(19) United States
(12) Patent Application Publication
(10) Pub. No.: US 2025/0196129 A1
(43) Pub. Date: Jun. 19, 2025

(54) Microfluidic Receiving Element, Microfluidic Device with a Receiving Element, Method for Producing a Microfluidic Receiving Element and Method for Using a Microfluidic Receiving Element

(71) Applicant: Robert Bosch GmbH, Stuttgart (DE)

(72) Inventor: Daniel Sebastian Podbiel, Rutesheim (DE)

(21) Appl. No.: 18/846,586

(22) PCT Filed: Mar. 23, 2023
(86) PCT No.: PCT/EP2023/057409

§ 371 Date: Sep. 12, 2024

(30) Foreign Application Priority Data
Mar. 24, 2022 (DE) 10 2022 202 862.7

(51) Int. Cl. B01L 3/00

(52) U.S. Cl. CPC B01L 3/502707; B01L 2200/12; B01L 2200/16; B01L 2300/0858; B01L 2300/163; B01L 2400/0406

(57) ABSTRACT

A microfluidic receiving element for a microfluidic device for processing fluids has at least one recess for receiving an aqueous solution, wherein the at least one recess is in the form of a cavity or through-hole. At least one protrusion is formed in a side wall of the recess, having a preferably hydrophilic surface quality, and the recess has a non-convex cross-sectional area in the plane of an upper side of the receiving element.

### PRIOR ART

The invention is based on a microfluidic receiving element, a microfluidic device with a receiving element, a method for producing a microfluidic receiving element and a method for using a microfluidic receiving element according to the preamble of the independent claims. The subject matter of the present invention is also a computer program.

Microfluidic analysis systems, known as lab-on-chips (LoCs), enable automated, reliable, compact and cost-effective processing of chemical or biological substances for medical diagnostics. By combining a number of operations for the targeted manipulation of fluids, complex microfluidic process sequences can be realized.

### DISCLOSURE OF THE INVENTION

Against this background, the approach presented here introduces a microfluidic receiving element, a microfluidic device with a receiving element, a method for producing a microfluidic receiving element and a method for using a microfluidic receiving element, furthermore a control unit which uses one of these methods, and finally a corresponding computer program according to the main claims. Advantageous embodiments of and improvements to the device specified in the independent claim are made possible by the measures presented in the dependent claims.

The microfluidic receiving element presented here can advantageously reduce the pinning that occurs at the edges of cavities in a microfluidic device, so that a spatially particularly homogeneous wetting of the receiving element in a flow cell can be achieved.

A microfluidic receiving element for a microfluidic device for processing fluids is presented. The receiving element has at least one recess for receiving an aqueous solution, wherein the at least one recess is shaped as a cavity or through-hole. The receiving element is characterized in that at least one protrusion with a preferably hydrophilic surface quality is formed in a side wall of the recess and the recess has a non-convex cross-sectional area in the plane of an upper side of the receiving element.

The microfluidic device can be, for example, a microfluidic analysis system in the form of a lab-on-chip (LoC) cartridge, which can include a microfluidic network for processing fluids, for example for analyzing patient samples. A suitable design of the microfluidic structures may be essential in order to provide a predetermined microfluidic functionality. The design of microfluidic structures, for example structures with holes or cavities, can depend on the properties of the liquid or liquids involved, such as surface tension, viscosity, density, polarity and in particular the wetting behavior as well as the specifications of the functionality to be provided. In some cases, the geometry of microfluidic structures, which can be used to realize a predetermined functionality, can be significantly determined or restricted by the wetting properties of the surface. One example of this are microfluidic structures that allow the aliquoting of a sample liquid into a plurality of compartments. Such structures can be realized, for example, by a receiving element with an arrangement of recesses such as cavities or through-holes, which can be introduced in a substrate and thus form a microfluidic receiving element for generating liquid compartments. For this purpose, the recess or a plurality of uniform recesses can be shaped as a cavity or through-hole, for example. Accordingly, the core of the invention presented here forms an improved microfluidic receiving element with an arrangement of at least one recess on a surface for receiving an aqueous solution, wherein the at least one recess is formed as a cavity or through-hole. The two-dimensional cross-sectional area of the at least one recess can be described within the plane defined by an upper side of the receiving element, via which the filling of the at least one recess takes place, by a geometric figure which has at least one protrusion or indentation, so that the said two-dimensional cross-sectional area of the at least one recess forms a non-convex subset of a Euclidean space. A subset of a Euclidean space is convex by definition if for any two points that belong to the set, their connecting line always lies entirely within the set. The design of the recess having at least one protrusion and a non-convex cross-sectional geometry has the particular advantage that, in the case of a phase interface with a significant surface energy or surface tension, the occurrence of so-called pinning of the phase interface to the edge of the recess can be significantly reduced. This can be explained by the fact that pinning a phase interface at the edge of a recess in the region of a protrusion or indentation requires an enlargement of the interface or a strong curvature of the interface, which is energetically unfavorable, so that the liquid can preferably penetrate into the recess.

According to one embodiment, the protrusion of the recess can be serrated or have at least one serration. In particular, one part, especially one side, of the serration can have the shape of an arc. In a particular embodiment, the one or more serrations can preferably have a segmented, Archimedean-spiral shape. The one or more serrations can therefore be formed alternately from straight and curved segments, for example. The arc-shaped segments can, for example, be shaped as a circular arc or as part of an elliptical arc or as part of a spiral-shaped arc. The straight segments can, for example, be oriented radially from the center of the recess. For example, a radius of a tip of the serration can be less than 25 μm and particularly preferably less than 15 μm, or the legs of the serration can be spread at an angle of less than 90 degrees, for example. This has the particular advantage that pinning of a phase interface at the edge of the recess can be prevented in a particularly efficient manner, since with a fillet radius of less than, for example, 25 μm or 15 μm of the tip, a locally strong curvature of the interface would be required for pinning at this point, the formation of which can be particularly unfavorable in terms of energy with regard to the interface energy. The improved pinning behavior is due to the surface energy of a phase interface, which must be applied for a phase interface to pin to the edge of a recess due to the associated deformation of the interface. The surface energy that must be provided to attach a phase interface to an edge of a recess correlates with the length of the edge and the associated increase in the phase interface. Thus, depending on the design of the edge, the surface energy to be applied by a phase interface for pinning can be adjusted. In principle, an edge with clearly pronounced protrusions and thus a significantly larger edge length (compared to a circular recess) with a comparable volume of the recess can also induce a particularly large surface energy for pinning. However, the surface-to-volume ratio of a recess generally increases with the edge length. This, in turn, can be a disadvantage for carrying out a chemical or biochemical reaction within the recess, for example, particularly in the event that undesired adsorption of reactants can occur on the walls of the recess, which in particular cannot be reduced to a sufficient extent by a suitable coating of the walls of the recess. In general, it may therefore be necessary to find a suitable compromise between improved filling characteristics on the one hand and an increase in the surface-to-volume ratio on the other when designing and dimensioning a recess. Accordingly, in addition to realizing protrusions that are as pronounced as possible and increasing the edge length, it can also be advantageous to realize protrusions with the sharpest possible shape, i.e. a small minimum radius at the tip of the protrusion, since a particularly high interfacial energy may be required locally for pinning at such a shaped edge.

According to a further embodiment, the recess may have at least one second protrusion, wherein the protrusion and the second protrusion may be arranged in a predetermined manner relative to one another and/or may resemble one another in shape and size. For example, the recess can be designed with a plurality of protrusions, wherein the protrusions can be arranged in a predetermined manner in relation to one another and can be similar in shape and size. This has the particular advantage that the recess can be filled from different directions from which the phase interface can approach the recess. This means that an essentially direction-independent, i.e. uniform filling characteristic can be achieved. For example, a recess shaped in this way can be used for aliquoting a liquid such as a sample liquid. After aliquoting, a parallelized analysis of the sample liquid can be carried out using geometric multiplexing, for example. In particular, the protrusions can be arranged in such a way that, for example, a star-shaped recess can be achieved. A subset of a Euclidean space is star-shaped by definition if there is a point from which every straight connecting line from this point to any point of the set lies completely within this set. For example, a two-dimensional cross-sectional area can be described by a geometric figure which has a circular or hexagonal basic shape on which the at least one protrusion can be arranged. This has the particular advantage that a low surface-to-volume ratio can be achieved. Due to the point-oriented design, the recess can also be advantageously designed to facilitate filling of the recess from different directions with which the phase interface can approach the recess.

According to a further embodiment, the side wall of the recess can be designed with a biocompatible coating in order to minimize adsorption of reactants on the side wall of the recess. For example, at least one wall of the recess adjacent to the at least one protrusion can have a hydrophilic surface quality. Additionally or alternatively, the at least one protrusion of the two-dimensional cross-sectional area can correspond to the formation of at least one side wall slat of the three-dimensional recess. In particular, if the side wall slat has a hydrophilic surface quality, the formation of a microfluidic capillary path in the side wall slat can advantageously be favored, which can support particularly reliable filling of the recess. The at least one side wall slat can be formed in particular over the entire height of the recess or only over a partial region of the recess, in particular the upper region of the recess adjacent to the inlet surface for a liquid. The latter offers the advantage that, on the one hand, improved penetration of a liquid into the recess can take place via the side wall slat and, on the other hand, discharge of a substance or upstream reagent that has dried exclusively at the bottom of the recess can be reduced if necessary, since the capillary path created by such a side wall slat is not continuous to the bottom of the recess. In an advantageous manner, such a recess can be produced, for example, by a dry etching process in a silicon substrate, wherein the geometry of the recess with the at least one protrusion and side wall slat at the entry surface is defined lithographically and, due to a partially isotropic character of the etching process, there is a continuous attenuation of the degree of development of the side wall slat with increasing depth of the etching, so that the side wall slat is only designed in a region of the recess adjacent to the entry surface. Furthermore, the recess can additionally or alternatively have a slightly bulbous end similar to a wide-necked round-bottom flask. Additionally or alternatively, the side walls of the at least one recess of the receiving element may have a biocompatible coating which advantageously minimizes adsorption of reactants, i.e. components of a reaction mix required for carrying out a biochemical such as a molecular diagnostic detection reaction, such as nucleic acids, primers, probe molecules or enzymes such as polymerases, on the walls of the recess. In this way, it is possible to design the at least one recess with protrusions, which increases the surface-to-volume ratio but also improves the filling behavior of the recess in accordance with the invention. At the same time, a high reaction efficiency can be achieved, since despite an increased surface-to-volume ratio compared to a cylindrically shaped recess, for example, adsorption of components of the reaction mix on the walls of the recess can be advantageously reduced by the coating.

According to a further embodiment, the side wall of the recess can be arranged within a tolerance range perpendicular to an upper side of the receiving element, in particular wherein the side wall can form an angle of between 85 and 95 degrees to the upper side. Additionally or alternatively, the protrusion can be formed adjacent to the top of the receiving element over the entire height of the side wall of the recess. For example, the at least one recess of the receiving element can have almost vertical side walls, which can enclose an angle of between 85 and 95 degrees to the top of the receiving element, whereby a cylindrical basic shape can be achieved. This has the particular advantage that the recess can be produced in a particularly simple way.

According to a further embodiment, a surface-to-volume ratio of the recess may be 1.0 to 2.0 times the surface-to-volume ratio of a cylindrical recess of the same volume with a circular cross-sectional area, in particular 1.0 to 1.5 times the surface-to-volume ratio. This has the particular advantage that the surface area of the recess, on which the components of a reaction mix can be adsorbed, can be particularly small. In this way, for example, the efficiency of a biochemical detection reaction carried out in a recess can be increased if necessary.

According to a further embodiment, the recess can have a non-convex but star-shaped cross-sectional area in the plane of the upper side of the receiving element. For example, the recess can have several protrusions that are arranged in a predetermined way in relation to each other, resulting in a star-shaped cross-sectional area. Such an advantageous design can, for example, achieve a low surface-to-volume ratio of the recess and, on the other hand, the point-oriented design of the recess can favor filling of the recess from different directions with which the phase boundary surface can approach the recess adjacent to the plane of the upper side of the receiving element.

According to a further embodiment, the receiving element can comprise several recesses. For example, the receiving element can have at least one second recess or several further recesses, wherein the recess and the second recess can be identical in shape and additionally or alternatively in size within a tolerance range (of, for example, 10 to/or 25 percent). For example, the receiving element can comprise an arrangement or array of several uniform recesses for carrying out the same reactions or reactions that differ from recess to recess. This has the advantage that analysis processes can be optimized and carried out in parallel in the recesses.

According to a further embodiment, the receiving element can have at least one substance which can be pre-stored in the recess and can be dissolved in an aqueous solution, for example for carrying out a detection reaction, in particular wherein the substance can be arranged or can be arrangeable in the protrusion or adjacent to the protrusion. For example, at least one dried substance can be stored in the at least one recess of the receiving element, which can be dissolved when an aqueous solution is received into the recess. This has the particular advantage that the recess can be used, for example, to carry out a special detection reaction. If there are a plurality of recesses in the receiving element, different detection reactions can be carried out in the recesses, for example, by using different detection reagents upstream in the recesses. In a further advantageous embodiment, the substance dried in the at least one recess of the receiving element is present in particular in at least one protrusion or adjacent to at least one protrusion of the at least one recess. This has the particular advantage that the substance is present in regions of the recess which, when the recess is filled in a flow cell in which a continuous flow of liquid can take place through the recess at times, can be less strongly flowed through than other regions of the recess. In this way, for example, flow-induced carryover of the upstream substance can be minimized. Furthermore, the substance stored in the at least one protrusion or adjacent to the at least one protrusion can preferably be present for the most part, for example more than 70% or more than 80% or completely, in the lower half of the recess and in particular at least partially adjacent to the edge of the bottom of the recess. In this way, the substance can be stored in the recess as far away as possible from the region of the recess with a particularly high flow rate in order to prevent undesired discharge of upstream substance from a recess during microfluidic processing of the receiving element. In addition, if the surface quality of the inner walls of the recess with the protrusions is hydrophilic (at least in partial regions), a particularly simple introduction of a substance into the protrusions can be achieved, for example by means of a fine dosing system, by first introducing an aqueous solution of the substance into the recess and then an evaporation of the solvent is brought about, wherein, due to the capillary forces acting on the liquid within the protrusions, storage of the substance in the protrusions or deposition on the walls of the protrusions can be promoted. Furthermore, depending on the geometric design of the protrusions of the recess and the existing degree of hydrophilicity of the surface of the protrusions and the surface tension of the liquid, the ratio of the amount of substance stored in the protrusions to the amount of substance stored in the recess outside of the substance stored in the volume surrounding the protrusions (in particular on the central bottom region of the recess) can be adjusted to a variable extent.

Overall, the described receiving element is characterized by an improved filling behavior of the recess of the improved microfluidic receiving element according to the invention. Advantageously, a particularly high level of reliability can be achieved when wetting a cavity. In particular, when filling the cavity with a liquid with a significant surface tension, such as an aqueous solution, entrapment of a gas previously present in the cavity, such as air, can be prevented in the cavity and in particular at the bottom of the cavity. In other words, an improved microfluidic filling behavior of recesses can be achieved. In particular, so-called dead-end structures such as cavities with a higher aspect ratio can also be completely filled than is the case with commonly designed, prior-art cavities. Furthermore, the device according to the invention can improve the fillability of recesses of any shape, wherein only a slight geometric modulation of the edge properties or of parts of the edge is required. The invention thus enables the functionalization of any geometries with regard to improved microfluidic fillability. In addition, the presented receiving element is characterized by reduced pinning of a phase interface to the edge of a recess. In particular, when using a receiving element with a plurality of recesses arranged on a surface in a configuration according to the invention, a spatially particularly homogeneous and temporally continuous wetting of the receiving element with the recesses can be achieved, whereby a particularly high reliability can be achieved in the microfluidic processing of the receiving element in a flow cell. The particularly advantageous filling behavior can be caused in particular by the formation of microfluidic capillary paths on the side walls of the recess. The resulting capillary forces can promote a wetting of the hydrophilic side walls. Wetting the side walls can prevent the undesired inclusion of gaseous media in particular, which may be present in the recess before wetting with the liquid. In addition, the liquid front hitting the recess can be prevented from sticking to the edge of the recess, which can also make it easier to fill the recess completely. Based on the newly established filling mechanism, the recess according to the invention can also be appropriately referred to as a capillary cavity and in particular as a silicon capillary cavity. The latter term stems in particular from the fact that the reactive ion depth etching process established in the MEMS industry provides a process that enables the high-precision production of such capillary cavities with capillary channels formed on the micrometer scale on the side walls of the cavities based on silicon. It is also possible to pre-store reagents in the recesses, for example to carry out different reactions in the recesses (geometric multiplexing). The recess presented here can have a positive effect on the carry-over behavior of at least one reagent stored upstream in a recess, i.e. in particular, a discharge from the at least one reagent stored upstream in the recess can be reduced when filling the recess.

In addition, a microfluidic device for processing fluids with a variant of the previously presented microfluidic receiving element is presented. The device can be a lab-on-chip cartridge, for example. The advantage of combining the microfluidic device with the receiving element is that all the advantages described above for processing a fluid or analyzing sample components dissolved in the fluid can be optimally implemented.

In addition, a method for producing a variant of the microfluidic receiving element presented above is presented. The method comprises a step of defining a geometry of at least one recess with a protrusion arranged in the side wall of the recess. This defining step can be carried out as a separate step, for example, in which a photoresist can be exposed accordingly. Alternatively, the defining step can also be carried out in parallel with a step of introducing the at least one recess into a substrate. In the introducing step, the recess can be carried out in a silicon substrate, for example, using reactive ion depth etching.

According to one embodiment, a plurality of recesses, each with the same geometry, can be defined in the defining step, wherein the plurality of recesses can be introduced in parallel into the substrate in the introducing step. For example, a parallel molding of a plurality of recesses in a silicon substrate can be carried out by reactive ion depth etching of the silicon substrate, wherein the geometry of the recesses can be defined beforehand via a lithographic step. This has the advantage that the effectiveness of the end product is increased and, at the same time, time and costs can be saved in production through parallelization.

In addition, a method for using a variant of the microfluidic receiving element presented above is presented. The method comprises a step of introducing an aqueous solution into the recess of the receiving element and a step of detecting a parameter of a reaction carried out using the introduced aqueous solution in the receiving element. For example, in the introducing step, the surface of the microfluidic receiving device with the arrangement of recesses can be brought into contact with an aqueous solution and the at least one recess can be filled with the aqueous solution. For example, at least one protrusion of a cavity can be wetted first and then the bottom of the cavity can be wetted with liquid and finally the entire volume of the cavity can be filled with liquid. A reaction can then be carried out within the recess, for example using upstream reagents and additionally or alternatively by heating the receiving element. In the detection step, a parameter of the reaction, such as an optical signal, in particular a fluorescence signal, is detected in order to obtain an analysis result.

These methods can be implemented in software or hardware, for example, or in a hybrid form of software and hardware, for example in a control unit.

The approach presented here also creates a control unit which is designed to carry out, control or implement the steps of a variant of a method presented here in corresponding devices. This embodiment of the invention in the form of a control unit can also solve the problem underlying the invention quickly and efficiently.

For this purpose, the control unit can have at least one computing unit for processing signals or data, at least one memory unit for storing signals or data, at least one interface to a sensor or an actuator for reading in sensor signals from the sensor or for outputting data or control signals to the actuator and/or at least one communication interface for reading in or outputting data that is embedded in a communication protocol. The computing unit may, for example, be a signal processor, a microcontroller or the like, wherein the memory unit may be a flash memory, an EEPROM, or a magnetic memory unit. The communication interface can be designed to read in or emit data in a wireless and/or wired manner, wherein a communication interface capable of reading in or emitting wired data can read in said data from a corresponding data transmission line, for example electrically or optically, or emit said data to a corresponding data transmission line.

In this context, the term “control unit” can be understood to mean an electrical device that processes sensor signals and emits control signals and/or data signals as a function thereof. The control unit can comprise an interface, which can be designed as hardware and/or software. For example, given a hardware design, the interfaces can be part of what is referred to as an ASIC system, which contains a wide variety of functions of the device. However, it is also possible that the interfaces are dedicated integrated circuits or consist at least partly of discrete components. When implemented as software, the interfaces can be software modules present, for example, on a microcontroller alongside other software modules.

Also advantageous is a computer program product or computer program comprising program code which is stored on a machine-readable carrier or storage medium, e.g., a semi-conductor memory, a hard disk memory, or an optical memory and used in order to perform, implement and/or control the steps of the method according to one of the embodiments described above, in particular if the program product or program is executed on a computer or a device.

Exemplary embodiments of the approach presented herein are shown in the drawings and explained in greater detail in the following description. The figures shows:

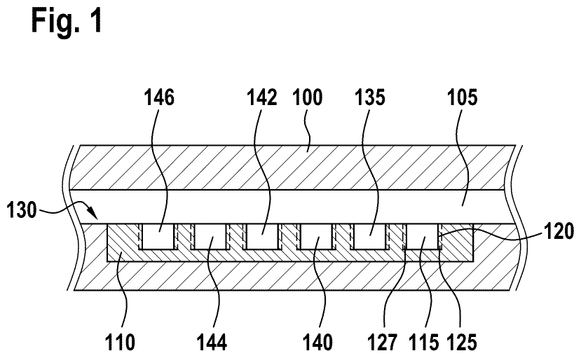

FIG. 1 is a schematic cross-sectional view of a microfluidic device according to an exemplary embodiment;

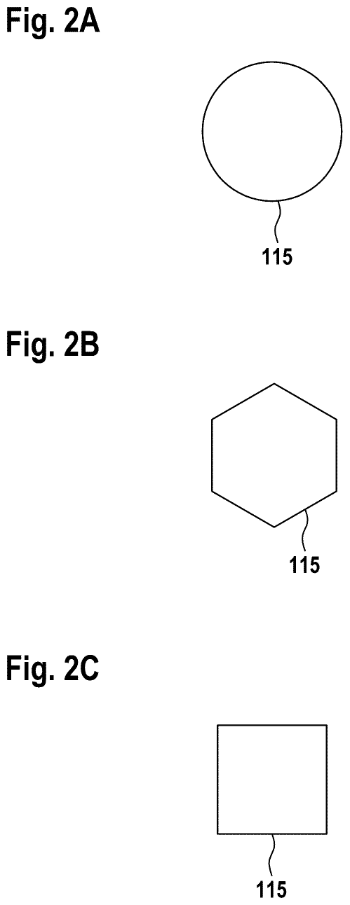

FIG. 2A a schematic top view of an exemplary embodiment of a recess;

FIG. 2B a schematic top view of an exemplary embodiment of a recess;

FIG. 2C a schematic top view of an exemplary embodiment of a recess;

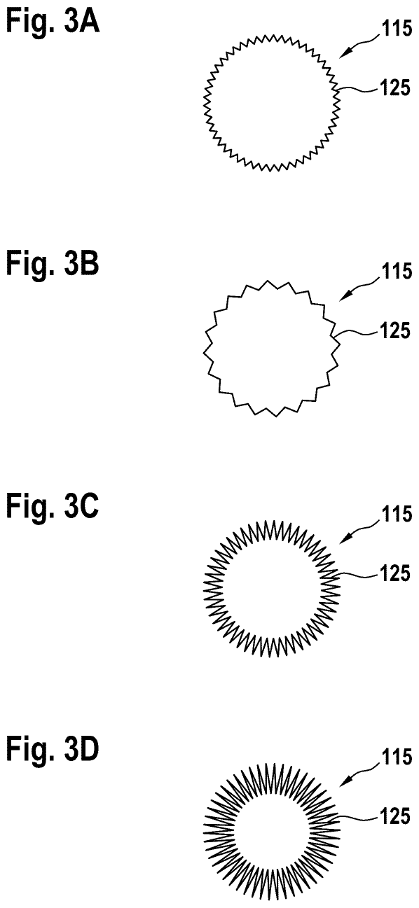

FIG. 3A a schematic top view of an exemplary embodiment of a recess;

FIG. 3B a schematic top view of an exemplary embodiment of a recess;

FIG. 3C a schematic top view of an exemplary embodiment of a recess;

FIG. 3D a schematic top view of an exemplary embodiment of a recess;

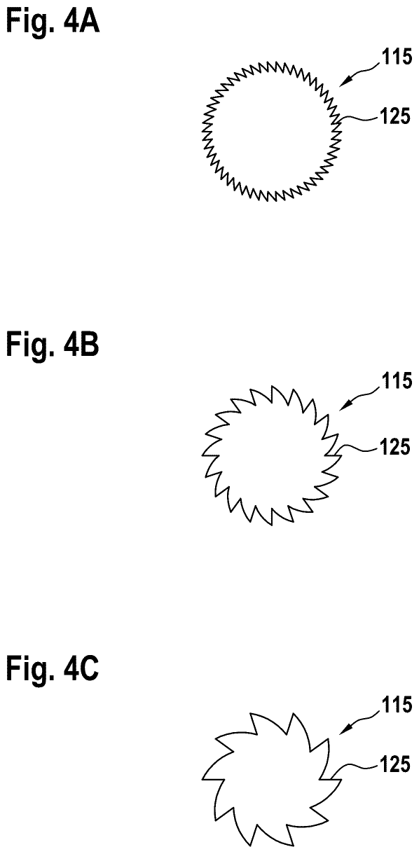

FIG. 4A a schematic top view of an exemplary embodiment of a recess;

FIG. 4B a schematic top view of an exemplary embodiment of a recess;

FIG. 4C a schematic top view of an exemplary embodiment of a recess;

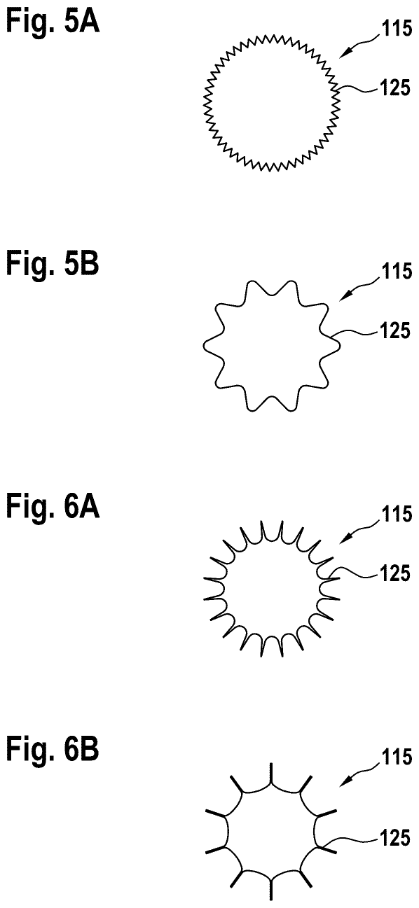

FIG. 5A a schematic top view of an exemplary embodiment of a recess;

FIG. 5B a schematic top view of an exemplary embodiment of a recess;

FIG. 6A a schematic top view of an exemplary embodiment of a recess;

FIG. 6B a schematic top view of an exemplary embodiment of a recess;

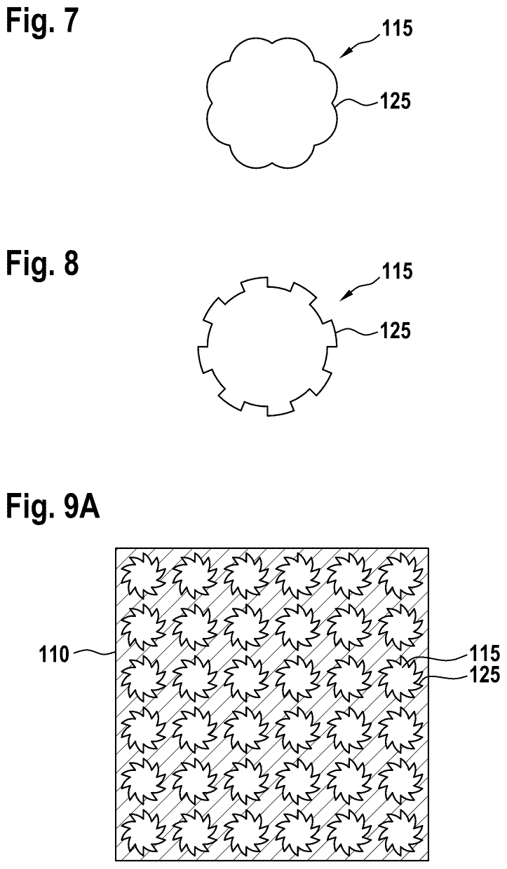

FIG. 7 a schematic top view of an exemplary embodiment of a recess;

FIG. 8 a schematic top view of an exemplary embodiment of a recess;

FIG. 9A a schematic top view of an exemplary embodiment of a receiving element;

FIG. 9B a microscopic top view of an exemplary embodiment of a receiving element;

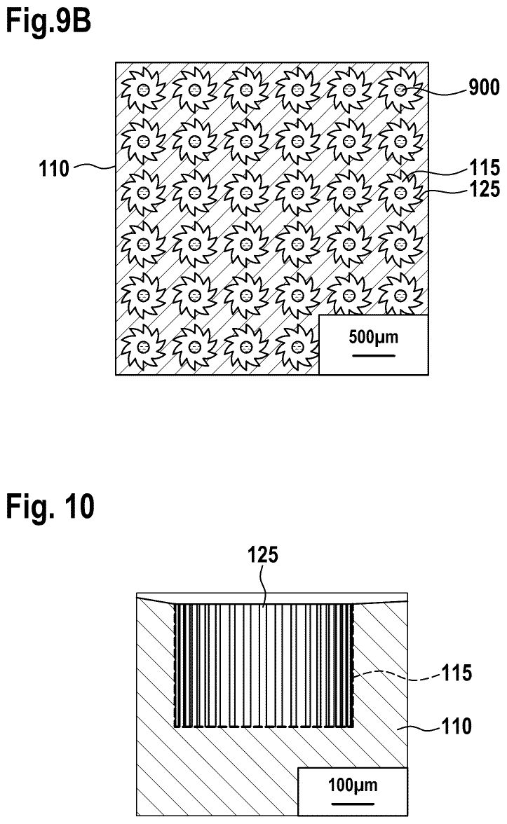

FIG. 10 a microscopic cross-sectional view of an exemplary embodiment of a receiving element;

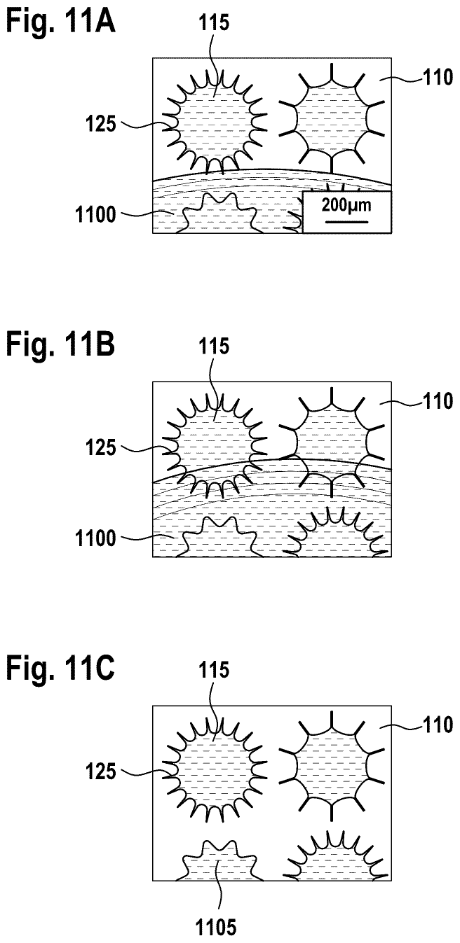

FIG. 11A a fluorescence microscopic top view of an exemplary embodiment of a receiving element during the microfluidic processing of the receiving element in a microfluidic device with a fluorescent aqueous solution;

FIG. 11B a fluorescence microscopic top view of an exemplary embodiment of a receiving element during the microfluidic processing of the receiving element in a microfluidic device with a fluorescent aqueous solution;

FIG. 11C a fluorescence microscopic top view of an exemplary embodiment of a receiving element during the microfluidic processing of the receiving element in a microfluidic device with a fluorescent aqueous solution;

FIG. 12 a flow chart of an exemplary embodiment of a method for producing a microfluidic receiving element;

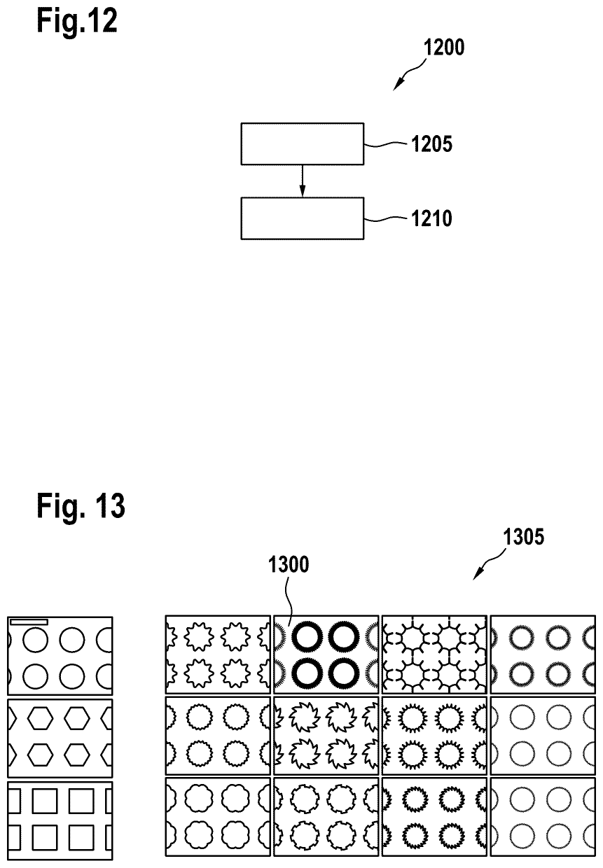

FIG. 13A microscopic top view of an exemplary embodiment of a lithographically structured photoresist on a silicon wafer;

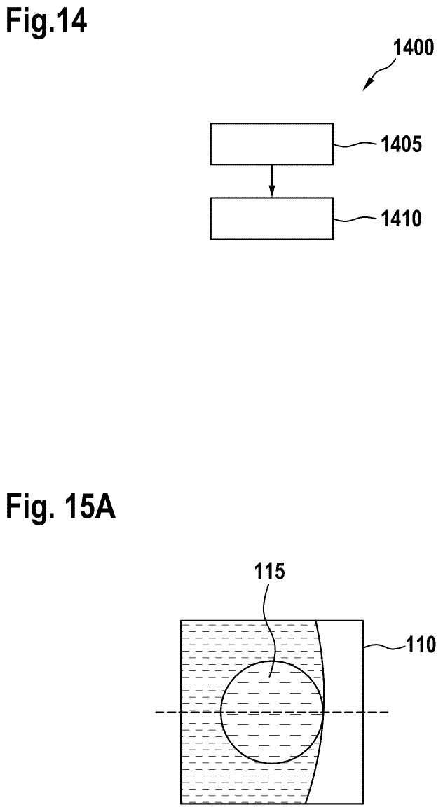

FIG. 14A flowchart of an exemplary embodiment of a method for using a microfluidic receiving element;

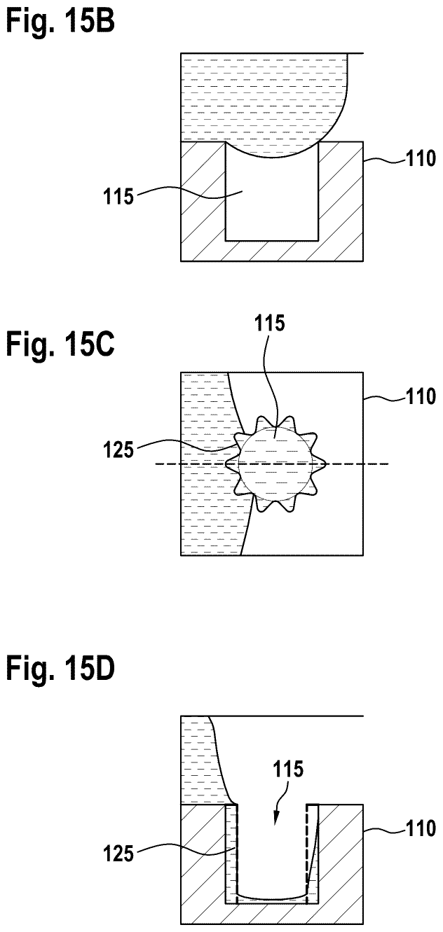

FIG. 15A a schematic top view of an exemplary embodiment of a receiving element during a method step of introducing;

FIG. 15B a schematic cross-sectional view of an exemplary embodiment of a receiving element during a method step of introducing;

FIG. 15C a schematic top view of an exemplary embodiment of a receiving element during a method step of introducing;

FIG. 15D a schematic cross-sectional view of an exemplary embodiment of a receiving element during a method step of introducing;

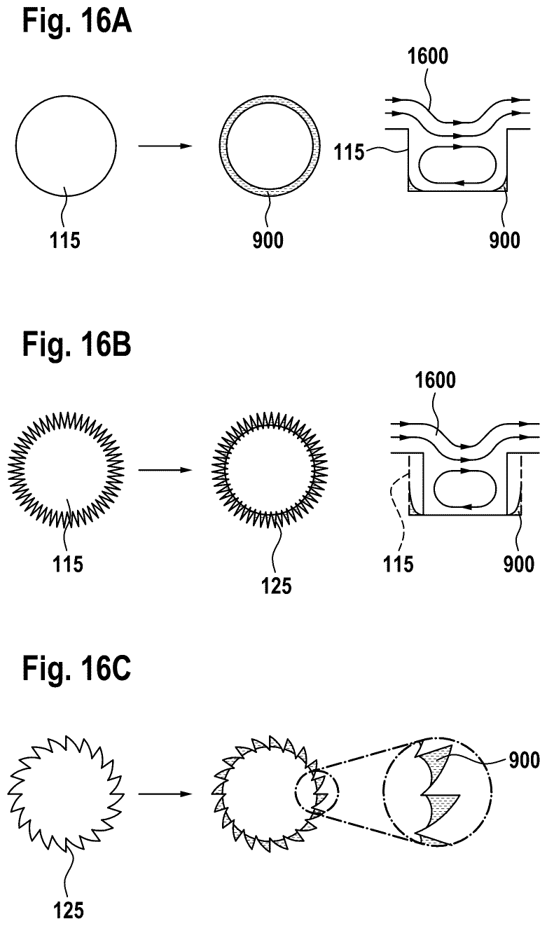

FIG. 16A a schematic sequence of a method step of the introducing;

FIG. 16B a schematic sequence of a method step of the introducing;

FIG. 16C a schematic sequence of a method step of the introducing; and

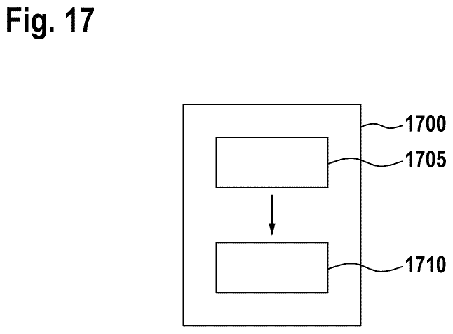

FIG. 17 a block diagram of an exemplary embodiment of a control unit for producing a microfluidic receiving element.

In the following description of advantageous exemplary embodiments of the present invention, identical or similar reference signs are used for elements shown in the various drawings which have a similar function, so a repeated description of these elements has been omitted.

FIG. 1 shows a schematic cross-sectional view of a microfluidic device 100 according to an exemplary embodiment. The device 100 is designed to process fluids and thus, for example, substances dissolved in a fluid. For this purpose, the device 100 comprises a microfluidic receiving element 110 arranged on a flow cell 105 in this exemplary embodiment. The receiving element 110 has a recess 115 for receiving an aqueous solution, wherein a protrusion 125 is formed in a side wall 120 of the recess 115, which can also be referred to as a side wall slat.

In one exemplary embodiment, the lateral dimensions of the entire microfluidic device 100 are only exemplarily 30×50 mm² to 80×220 mm² and the dimensions of the flow cell 105 are exemplarily 5×5×0.5 mm³ to 15×15×1 mm³. In one exemplary embodiment, the lateral dimensions of the receiving element 110 are 5×5 mm² to 15×15 mm² and the height is 300 μm to 800 μm, for example. In other exemplary embodiments, the lateral dimensions of the device can be, for example, 10×10 mm² to 200×200 mm², the dimensions of the flow cell, for example, 3×3×0.3 mm³ to 30×30×3 mm³, the dimensions of the receiving element, for example, 3×3 mm² to 30×30 mm² and the height 200 μm to 1100 μm.

In the exemplary embodiment shown here, the recess also has, by way of example, a second protrusion 127, which is only arranged opposite the protrusion 125 by way of example in the figure shown here. In this exemplary embodiment, the protrusion 125 and the second protrusion 127 have the same shape and size. The side wall 120 of the recess is arranged at an angle of 90 degrees perpendicular to an upper side 130 of the receiving element 110. In other exemplary embodiments, the side wall can be arranged perpendicular to the upper side of the receiving element within a tolerance range, for example at an angle of between 85 and 95 degrees to the upper side. Moreover, in this exemplary embodiment, the side wall 120 adjacent to the protrusions 125, 127 is only exemplarily designed with a hydrophilic surface quality. In another exemplary embodiment, the side wall can additionally or alternatively have one or more side wall slats formed in addition to the one or more protrusions, for example with a variable cross-sectional profile, i.e. side wall slats which only extend over a partial region of the recess, for example, in particular the upper region of the recess adjacent to the top of the receiving element, and additionally or alternatively have a biocompatible coating, for example to minimize adsorption of reactants on the surface of the recess.

In this exemplary embodiment, the receiving element 110 comprises only by way of example a second recess 135 in addition to the recess 115, as well as only by way of example a third recess 140, a fourth recess 142, a fifth recess 144 and a sixth recess 146, wherein all recesses 115, 135, 140, 142, 144, 146 are similar in shape and size. Due to the exemplary design of the recesses 115, 135, 140, 142, 144, 146 with protrusions 125, 127 or with side wall slats, the filling behavior of the recesses 115, 135, 140, 142, 144, 146 can be improved by these slats, which can also be referred to as capillary paths, when liquids are brought into controlled contact with the microfluidic receiving element 110 via the flow cell 105, since improved wetting of the microcavity can be achieved by the side wall slats. The capillary forces acting on the liquid during the wetting of a recess 115, 135, 140, 142, 144, 146 correlate on the one hand with the affinity of the liquid to the side wall 120 and on the other hand with the width of the protrusion 125, 127. For aqueous (polar) solutions, for example, a hydrophilic quality of the side walls is therefore particularly advantageous on the one hand, and on the other hand a particularly strong influence of the surface forces acting on the liquid when wetting the side wall slats can be achieved due to the small width of the side wall slats.

In other exemplary embodiments, the size and number of recesses may vary. For example, to specify the receiving element for carrying out a multiplex detection with reagents stored in the recesses, the number of recesses can be 1 to 1,000, preferably 10 to 200, and the volume of a recess can be, for example, 2 nl to 110 nl, preferably 10 nl to 50 nl. The diameter of a recess can be, for example, 110 μm to 1100 μm, preferably 200 μm to 500 μm. For an exemplary specification of the receiving element for carrying out a digital detection, the number of recesses can be, for example, 110 to 110,000, preferably 1,000 to 30,000, the volume of a cavity can be 10 pl to 50 nl, preferably 110 pl to 10 nl, and the diameter of a cavity can be, for example, 20 μm to 200 μm, preferably 30 μm to 110 μm.

FIGS. 2A, 2B and 2C each show a schematic top view representation of an exemplary embodiment of a recess 115. The recess 115 shown here corresponds to or is similar to the recess described in the previous figure. The geometries of such recesses with a circular (2A), hexagonal (2B) or square (2C) shape outlined here are examples of the prior art.

A circular geometry shown in FIG. 2A, for example, has the particular advantage that the surface-to-volume ratio of a liquid or reaction compartment is particularly low. In this way, for example, the influence of the interaction of components of an aqueous solution in the liquid compartment with the walls of the liquid compartment is minimizable. For example, the efficiency of a chemical or biochemical reaction carried out in the liquid compartment can be increased.

A hexagonal geometry shown in FIG. 2B, for example, has the particular advantage that the volume of liquid that can be analyzed on a predetermined area can be maximized with a hexagonally dense arrangement of the reaction compartments and a constant predetermined minimum wall thickness between the reaction compartments.

A square geometry shown in FIG. 2C, for example, has the particular advantage that such compartments can be produced in a particularly simple way by potassium hydroxide-based etching of silicon with high precision in a silicon substrate of suitable crystallographic orientation.

More generally formulated, there is thus in particular a two-dimensional cross-sectional area of a recess 115 for forming a microfluidic liquid or reaction compartment, which forms a convex subset of a Euclidean space. A subset of a Euclidean space is convex by definition if for any two points that belong to the set, their connecting line always lies entirely within the set.

In other words, such cavities or through-holes, i.e. generally recesses which are used to form microfluidic liquid or reaction compartments in a receiving element, have a two-dimensional cross-sectional area in the prior art with a mostly circular, hexagonal or, more rarely, square shape, via which a mostly aqueous liquid, such as a sample liquid, enters the liquid compartment. In the prior art, for example, through-holes are used for this purpose, as these can be completely filled with a liquid flowing in from one side of the substrate without air being trapped in them during filling, as this can escape on the opposite side of the substrate. However, such through-holes make it difficult, for example, to introduce reagents into the compartments, as these can only be deposited on the side walls of the through-holes, but cannot be dried on the bottom of a recess (as is the case with a cavity). Cavities are therefore also used in particular for the provision of reaction compartments with introduced, upstream reagents. The reagents can be introduced into the wells and dried in a controlled and technically established manner, for example using a contactless fine dispensing system. Furthermore, in the case of a receiving element with cavities, it is possible to contact the underside of the substrate over a large area, for example with a heating and/or cooling device, in order to enable direct, i.e. as immediate as possible, temperature control of the receiving element.

In addition to the aforementioned advantages of such cavity-based microfluidic receiving elements, however, there is a particular risk of gas, especially air, being trapped in the cavities, thus preventing the cavities from being completely filled with a liquid, for example with an aqueous solution with significant surface tension. Cavities with a high aspect ratio are particularly susceptible to the inclusion of air or generally gas bubbles in the cavities when the receiving element is brought into contact with an aqueous liquid to fill the cavities. This behavior can be explained in particular by the fact that the liquid meniscus at the edge of the cavity is pinned to the edge present here, the cavity is spanned by the phase boundary surface-stabilized by the surface tension—and then this is abruptly migrated over. As a result, air or gas bubbles are trapped in the cavities, resulting in incomplete filling of the cavities.

Furthermore, when using a flow cell for controlled contact of at least one liquid with a receiving element, for example, the pinning of the liquid meniscus present at the edges of the individual cavities, for example an air-water interface, can lead to spatially and temporally inhomogeneous wetting of the receiving element, which in turn, in addition to favoring incomplete filling of the individual cavities, can also lead to incomplete wetting of the receiving element as a whole. When using a three-phase system known in the prior art, consisting of a gaseous phase such as air, an aqueous phase such as a sample liquid for filling the cavities and a third, immiscible phase as a sealing liquid, such as a fluorinated hydrocarbon for sealing the cavities, it is possible, particularly when sealing the cavities previously filled with the aqueous phase using a flow cell and a limited volume, such as a fluorinated hydrocarbon for sealing the cavities, the third phase may break through the limited volume of the aqueous phase, particularly when sealing the cavities previously filled with the aqueous phase using a flow cell and a limited volume of the aqueous phase, that is, the sample liquid-sealing liquid interface breaks through the sample liquid-air interface, so that a sealing liquid-air interface is present, whereby filling of all cavities of the receiving device with the aqueous phase can be impaired in a particularly disadvantageous manner, for example in the event that sealing liquid penetrates into a cavity before it comes into contact with the sample liquid.

FIGS. 3A, 3B, 3C and 3D each show a schematic top view representation of an exemplary embodiment of a recess 115. The recess 115 shown here corresponds to or is similar to the recess described in the preceding figures, wherein a plurality of uniform protrusions 125 of the recess 115 are formed in a serrated shape. Due to the underlying circular or cylindrical geometry of the recess 115, the overall shape is star-shaped. Mathematically, the geometries of the two-dimensional cross-sectional areas of the recess 115 shown here can be described in a simple manner in a polar coordinate system and can be distinguished from one another on the basis of the type of edge. This is the serrated edge

$$r ( θ ) = r 0 + k f ( n / ( 2 π ) θ )$$

with a triangular wave function f(t) describable by

$$f ( t ) = \{ \begin{matrix}4 t for 0 \leq mod ( t , 1 ) \leq 0.25 \\ 1 - 4 ( t - 0.25 ) for 0.25 \leq mod ( t , 1 ) \leq 0.75 \\ - 1 + 4 ( t - 0.75 ) for 0.75 \leq mod ( t , 1 ) \leq 1\end{matrix}$$

FIGS. 4A, 4B and 4C, each showing a schematic top view illustration of an exemplary embodiment of a recess 115, wherein a plurality of uniform protrusions 125 of the recess 115 are formed as curved serrations. The underlying circular or cylindrical geometry of the recess 115 results in an overall segmented Archimedean-spiral shape. Mathematically, the geometries of the two-dimensional cross-sectional areas of the recess 115 shown here can be described in a simple manner in a polar coordinate system. Thus, the segmented Archimedean spiral modulated edge can be described by the formula:

$$r ( θ ) = r 0 + k Mod ( n θ , 2 π )$$

FIGS. 5A and 5B each show a schematic top view representation of an exemplary embodiment of a recess 115. The recess 115 shown here corresponds to or is similar to the recess described in the preceding figures, wherein a plurality of uniform protrusions 125 of the recess 115 are shaped as rounded serrations. The underlying circular or cylindrical geometry of the recess 115 results in an overall sinusoidal corrugated shape. Mathematically, the geometries of the two-dimensional cross-sectional areas of the recess 115 shown here can be described in a simple manner in a polar coordinate system. The sinusoidal wavy edge can be described using the formula:

$$r ( θ ) = r 0 + k sin ( n θ )$$

FIGS. 6A and 6B each show a schematic top view representation of an exemplary embodiment of a recess 115. The recess 115 shown here corresponds to or is similar to the recess described in the preceding figures, wherein a plurality of uniform protrusions 125 of the recess 115 are shaped as flat serrations or rays. The underlying circular or cylindrical geometry of the recess 115 results in an overall truncated-diverging modulated shape. Mathematically, the geometries of the two-dimensional cross-sectional areas of the recess 115 shown here can be described in a simple manner in a polar coordinate system. Thus, the truncated-diverging modulated edge can be described with the formula:

$$r ( θ ) = r 0 + k min [ abs [ 10 tan ( n , θ ) ] , m ]$$

FIG. 7 shows a schematic top view of an exemplary embodiment of a recess 115. The recess 115 shown here corresponds to or is similar to the recess described in the preceding figures, wherein a plurality of uniform protrusions 125 of the recess 115 are shaped as rounded serrations or curves. The underlying circular or cylindrical geometry of the recess 115 results in an overall sinusoidal serrated shape. Mathematically, the geometry of the two-dimensional cross-sectional area of the recess 115 shown here can be described in a simple manner in a polar coordinate system. The sinusoidal serrated edge can be described using the formula:

$$r ( θ ) = r 0 + k sig [ sin ( n θ ) ] sin ( n θ )$$

with the Signum function

$$sig [ x ] = \{ \begin{matrix}1 for x \geq 0 \\ - 1 for x < 0\end{matrix}$$

FIG. 8 shows a schematic top view of an exemplary embodiment of a recess 115. The recess 115 shown here corresponds to or is similar to the recess described in the preceding figures, wherein a plurality of uniform protrusions 125 of the recess 115 are formed as steps. Due to the underlying circular or cylindrical geometry of the recess 115, the overall shape is modulated in steps. Mathematically, the geometry of the two-dimensional cross-sectional area of the recess 115 shown here can be described in a simple manner in a polar coordinate system. Thus, the step-shaped modulated edge can be described by the formula:

$$r ( θ ) = r 0 + k sig [ sin ( n θ ) ]$$

wherein r0, k, n, m represent fixed but customizable geometry parameters.

In other words, the preceding FIGS. 3, 4, 5, 6, 7 and 8 can be described as follows:

In each of these exemplary embodiments, the recess 115 is formed with a non-convex and star-shaped cross-sectional area based on a circular cross-sectional area, the edge of which is modulated in different ways. The recess 115 is in each case advantageously usable for a microfluidic generation of liquid compartments in the recess 115. In advantageous exemplary embodiments, depending on the choice of geometry parameters, the surface-to-volume ratio of the recess can be 1.0 to 2.0 times the surface-to-volume ratio of a cylindrical recess of the same volume with a circular cross-sectional area, in particular 1.0 to 1.5 times the surface-to-volume ratio.

Among the embodiments described above, particularly advantageous embodiments result depending on the choice of the design shape and the geometry parameters for a given application and the selected coating of the surface, in particular with regard to the properties of the at least one recess 115 of the receiving element, such as surface-to-volume ratio, surface quality and the wetting properties of the surface. In addition, an embodiment according to the invention has advantages with regard to the process parameters that can be selected for use of the device, such as the flow rate when the liquid is introduced into the flow cell, the spatial/direction-dependent uniformity of the filling characteristics and the choice of properties of the liquids used, such as polarity and viscosity. There are also advantages with regard to the application-specific requirements, such as the adsorption behavior of reactants involved in a detection reaction, the acceptable amount of reagent discharged from a recess during microfluidic processing or the robustness of a detection reaction with regard to a fluctuation in the concentration of reactants.

FIGS. 9A and 9B each show a schematic (FIG. 9A) and a microscopic (FIG. 9B) top view of an exemplary embodiment of a receiving element 110. The receiving element 110 shown here corresponds to or is similar to the receiving element described in the preceding FIG. 1. In each of these exemplary embodiments, the receiving element 110 has an arrangement of a plurality of recesses 115, which are merely exemplarily formed with the cross-section of an eightfold segmented Archimedean spiral. In this exemplary embodiment, the receiving element 110 is merely exemplarily designed on the basis of a silicon substrate, wherein the recesses 115, which can also be referred to as capillary cavities, were exemplarily introduced into the silicon substrate by means of reactive ion depth etching. The (almost) vertical side walls produced in this way have protrusions 125 or side wall slats that are formed up to the bottom of the capillary cavity, which lead to a particularly advantageous filling behavior of a capillary cavity designed in this way. In the receiving element 110 shown in FIG. 9B, a substance 900 that is soluble in an aqueous solution for carrying out a detection reaction is arranged in each recess 115, by way of example only. The scaling bar shown in FIG. 9B corresponds to a length of 500 μm.

FIG. 10 shows a microscopic cross-sectional view of an exemplary embodiment of a receiving element 110. The receiving element 110 shown here corresponds to or is similar to the receiving element described in the preceding FIGS. 1 and 9. In the illustration shown here, a fracture view along the cross-section of a recess 115 or a capillary cavity with a plurality of protrusions 125 or side wall slats is shown. The side wall slats are realized along the entire height of the capillary cavity. The scaling bar has a length of 100 μm.

FIGS. 11A, 11B and 11C each show a microscopic top view of an exemplary embodiment of a receiving element 110. The receiving element 110 shown here corresponds to or is similar to the receiving element described in the preceding FIGS. 1, 9 and 10. In this context, a filling of the microfluidic receiving element 110 with an arrangement of recesses 125 or capillary cavities with a colored aqueous solution 1100 and the sealing of the capillary cavities with a second liquid 1105 that is not miscible with the aqueous solution is shown as an example.

The microfluidic receiving element 110 with the capillary cavities is implemented, for example, in a flow cell, which enables controlled contact between the receiving element 110 and the liquids 1100, 1105. The three FIGS. 11A, 11B, 11C show the filling process in chronological order. FIGS. 11A, 11B, 11C illustrate in particular the advantageous filling mechanism which results from the cavity shape according to the invention when the capillary cavities are wetted with the aqueous phase:

As can be seen in FIG. 11A, immediately after the liquid meniscus describing the phase interface comes into contact with a protrusion 125 of a capillary cavity, the aqueous solution 1100 penetrates into the cavity, wherein the bottom of the cavity is wetted with the solution 1100 and in particular also the other protrusions of the cavity. The wetting process of the protrusions is favored in particular by the capillary forces acting on the liquid within the protrusions, since the protrusions have a hydrophilic surface quality and the small spatial dimensions of the protrusions, which are in particular below the capillary length of the liquid used, lead to a wetting behavior driven by surface forces. In this way, wetting of the protrusions is particularly favored and the protrusions initially exhibit the highest fluorescence signal of all regions of a cavity. The scaling bar in FIG. 11A corresponds to a length of 200 μm.

After wetting the protrusions, the almost cylindrical base volume of the capillary cavities enclosed by the protrusions is filled. Filling takes place continuously from the bottom of the cavity upwards to the top of the receiving element 110, wherein the capillary cavities are completely filled without trapping gas. An almost complete filling of a capillary cavity can already be achieved before the meniscus of the phase interface completely overflows the capillary cavity. This is indicated in particular by the similar fluorescence signal level of the capillary cavities in FIGS. 11B and 11C, which can be observed before a cavity migrates through the phase interface and after a cavity has been overlaid with a second immiscible (and non-fluorescent) liquid 1105. The spatially homogeneous fluorescence signal of the capillary cavities in FIG. 11C indicates in particular that it was possible to achieve complete filling of the capillary cavities without the inclusion of gas bubbles.

FIG. 12 shows a flowchart of an exemplary embodiment of a method 1200 for producing a microfluidic receiving element. The method 1200 comprises a step 1205 of defining a geometry of at least one recess having a protrusion arranged in the side wall of the recess, and a step 1210 of introducing the at least one recess into a substrate.

In this exemplary embodiment, a plurality of recesses, each having an identical geometry, is only defined by way of example in the step 1205 of defining, wherein in the step 1210 of introducing the plurality of recesses are introduced in parallel into the substrate.

In one exemplary embodiment, the geometry of at least one recess with a non-convex cross-sectional area can be defined in the defining step.

In an advantageous embodiment of the method for producing an improved microfluidic receiving element, a parallel introduction of a plurality of recesses into a silicon substrate can be carried out in the introducing step by reactive ion depth etching of the silicon substrate, wherein the geometry of the recesses can be defined beforehand via a lithographic defining step.

In an advantageous further development of the method for producing an improved microfluidic receiving element, a coating step can additionally be carried out after the introducing step, in which an at least partial coating of the receiving element and in particular a partial coating of the surface of the recesses is carried out in order to provide a particularly hydrophilic and additionally or alternatively a particularly biocompatible surface quality of the recesses. For example, the coating can improve the wetting of the capillary cavities and also reduce the adsorption of reactants on the surface of the recess. For example, the coating can be a silanization coating with a polyethylene glycol molecule.

FIG. 13 shows a microscopic top view of an exemplary embodiment of a lithographically structured photoresist 1300 on a silicon wafer 1305. This was created, for example, in a method step of defining, as described in the previous FIG. 12, in order to subsequently introduce (capillary) cavities into the silicon wafer by means of, for example, reactive ion depth etching. The scaling bar in the top left image corresponds to a length of 500 μm, for example. The total of 15 images each show sections of arrangements of openings in the photoresist for shaping the cavities and forming various microfluidic receiving elements. On the left-hand side, three different convex (circular, hexagonal, square) openings of the photoresist are shown, whereas on the right-hand side, twelve different non-convex (but star-shaped) openings of the photoresist are shown. It can be seen that the lithographic definition of the structuring by means of the exposure and development of a photoresist makes it possible to produce the various capillary cavity designs, in particular those with protrusions or indentations, with high precision. In one exemplary embodiment, for example, the exposure can be carried out using an exposure device with a mask or using a laser direct beam recorder, wherein precision in the μm range can be achieved in each case. In this way, for example, subsequent reactive ion depth etching can be used to precisely produce side wall slats or capillary channels on the side walls of the cavities. In one exemplary embodiment, the hydrophilic wetting properties of the side walls of the cavity generate high capillary pressures in the capillary channels, which lead to rapid wetting of the cavity side wall. After wetting the side wall, any trapped air bubbles are moved out of the cavity by the applied buoyancy force.

FIG. 14 shows a flowchart of an exemplary embodiment of a method 1400 for using a microfluidic receiving element. The method 1400 comprises a step 1405 of introducing an aqueous solution into the recess of the receiving element, and a step 1410 of detecting a parameter of a reaction carried out using the introduced aqueous solution in the receiving element.

In one exemplary embodiment, the step 1405 of introducing comprises, by way of example, contacting, wherein the surface of the microfluidic receiving device is brought into contact with an arrangement of recesses with an aqueous solution and subsequently, the at least one recess is filled with the aqueous solution. In one exemplary embodiment, at least one protrusion of a cavity is first wetted during filling and then the bottom of the cavity is wetted with liquid, for example. The entire volume of the cavity is then filled with liquid, only by way of example.

FIGS. 15A, 15B, 15C and 15D each show schematic representations of an exemplary embodiment of a receiving element 110 during a method step of introducing as described in the preceding FIG. 14. Specifically, FIG. 15A and FIG. 15B outline a filling characteristic of an ordinary circular cavity and FIG. 15C and FIG. 15D outline a characteristic for a recess 115 with exemplary hydrophilic protrusions 125.

As outlined in FIGS. 15A and 15B, a cavity with a circular cross-sectional area results in pinning at the upper edge of the cavity and thus a spanning of the cavity by a phase boundary surface. This may result in unwanted air entrapment and therefore incomplete filling of a cavity. This can be the case, for example, if the liquid has a high surface tension or if the upper side of the receiving element has a hydrophobic surface quality, at least in partial regions, which leads to the formation of a large contact angle>90° on contact with an aqueous phase.

In contrast, in a capillary cavity with hydrophilic side wall slats—as shown in FIGS. 15C and 15D—as soon as the liquid meniscus of the phase interface meets the edge of the cavity, the hydrophilic side wall slats of the cavity are wetted by capillary forces, wherein the bottom of the cavity is also wetted. As a result, air can be trapped in the cavity and thus incomplete filling of the cavity can be prevented.

Even when an improved microfluidic receiving element 110 is brought into contact with an aqueous liquid at a high propagation velocity of the phase interface, i.e. in particular at a velocity at which the inertia of the introduced liquid does not initially permit complete filling of the cavity, a complete filling of the cavity can ultimately be expected (with suitable alignment of the receiving element), since the air initially trapped in the cavity, after wetting of the side walls induced by capillary forces, can be displaced from the cavity by the buoyancy force acting on them, so that a complete filling of the cavity with the aqueous liquid results.

FIGS. 16A, 16B and 16C each show a schematic sequence of a method step of introducing, as described in the preceding FIG. 14. In FIG. 16A, the recess 115 is merely exemplarily shaped circularly, in FIG. 16B, the recess 115 is merely exemplarily shaped with a serrated edge, and in FIG. 16C, the recess 115 is merely exemplarily shaped with a segmented archimedean-spiral-shaped modulated edge. The recess 115 shown in each case merely comprises an upstream substance 900, which can also be referred to as a reagent, by way of example.

In addition to an advantageous filling characteristic, a capillary cavity with side wall slats can also be particularly advantageous in combination with a reagent stored upstream in the capillary cavity in order to minimize the carryover induced by a reagent stored upstream in the cavity when filling the cavity. The upstream reagent is first introduced into the capillary cavity in the form of a solution using a fine dosing system, for example, and then dried in the cavity. The dried reagent is deposited in particular on the edge region of the bottom and the lower region of the side walls of the cavity-due to the distribution of the liquid solution within the cavity caused by capillary forces.

This is shown schematically in the top view illustrations on the left-hand side of FIGS. 16A, 16B and 16C. In the case of capillary cavities with side wall slats, i.e. with at least one protrusion 125, the reagent is deposited and stored within the side wall slats, as shown by way of example only in FIG. 16C shown here.

Whereas with a circular (or generally convex) cross-sectional geometry of a cavity, the deposited reagent is close to the region of the cavity through which the liquid flows, if the reagent is deposited in side wall slats, the reagent can be better shielded from the region through which the liquid flows. This is shown schematically by means of the flow lines 1600 in the cross-sectional views on the right-hand side of FIGS. 16A and 16B.

Furthermore, in order to create liquid compartments in recesses 115 in the form of circular cavities or perforations in a substrate, the recesses must first be filled with the usually aqueous liquid. This can lead to undesirable entrapment of gas such as, for example, air at the bottom of the cavity, particularly when cavities are used. Furthermore, pinning of a phase interface, such as an air-water interface, can occur at the edge of the recess 115 via which the filling takes place, which can also have a detrimental effect on the filling behavior of a recess and also on the filling behavior of an arrangement comprising a plurality of recesses in a substrate, i.e. a receiving element, which is present in particular in a flow cell. An improved geometric design of the recesses 115 for forming liquid or reaction compartments, i.e. in particular by modifying the geometry of the cavities or through-holes, as shown in FIGS. 16B and 16C, permits improved filling of the recesses, in particular with aqueous solutions (with a significant surface tension).

FIG. 17 shows a block diagram of an exemplary embodiment of a control unit 1700 for producing a microfluidic receiving element. The control unit 1700 comprises a defining unit 1705 for controlling a definition of a geometry of at least one recess with a protrusion arranged in the side wall of the recess. In addition, the control unit 1700 comprises an introducing unit 1710 for controlling the introduction of the at least one recess into a substrate.

If an exemplary embodiment comprises an “and/or” conjunction between a first feature and a second feature, this is to be read such that the exemplary embodiment according to one embodiment comprises both the first feature and the second feature and according to a further embodiment comprises either only the first feature or only the second feature.

1. A microfluidic receiving element for a microfluidic device for processing fluids, the receiving element comprising:
at least one recess for receiving an aqueous solution, the at least one recess formed as a cavity or through-hole,
wherein at least one protrusion is formed in a side wall of the recess, and
wherein the recess has a non-convex cross-sectional area in a plane of an upper side of the receiving element.

2. The microfluidic receiving element according to claim 1, wherein the protrusion of the recess is shaped in a serrated manner or has at least one serration.

3. The microfluidic receiving element according claim 1, wherein;
the recess comprises at least a second protrusion, and the protrusion and the second protrusion are arranged in a predetermined manner with respect to each other.

4. The microfluidic receiving element according to claim 1, wherein the side wall of the recess is includes a biocompatible coating configured to minimize adsorption of reactants on the side wall of the recess.

5. The microfluidic receiving element according to claim 1, wherein;
the side wall of the recess is arranged within a tolerance range perpendicular with respect to the upper side of the receiving element, and/or
the protrusion is formed adjacent to the upper side of the receiving element over the entire height of the side wall of the recess.

6. The microfluidic receiving element according to claim 1, wherein a surface-to-volume ratio of the recess is 1.0 to 2.0 times the surface-to-volume ratio of a cylindrical recess of the same volume having a circular cross-sectional area.

7. The microfluidic receiving element according to claim 1, wherein the recess has a non-convex but star-shaped cross-sectional area in the plane of the upper surface of the receiving element.

8. The microfluidic receiving element according to claim 1, having further comprising:
at least one substance pre-stored in the recess and configured to be dissolved in an aqueous solution for carrying out a detection reaction,
wherein the substance is arranged or is configured to be arranged in the protrusion.

9. A microfluidic device for processing fluids comprising:
the microfluidic receiving element according to claim 1.

10. A method for producing a microfluidic receiving element, the method comprising:
defining a geometry of at least one recess having a protrusion arranged in a side wall of the protrusion, the at least one recess being formed as a cavity or through-hole configured to receive an aqueous solution, and the recess having a non-convex cross-sectional area in a plane of an upper side of the receiving element; and
introducing the at least one recess into a substrate.

11. The method according to claim 10, wherein;
the defining of the geometry includes defining the geometry of a plurality of recesses each having a same geometry, and
the introducing includes introducing the plurality of recesses in parallel into the substrate.

12. A method for using the microfluidic receiving element according to claim 1, the method comprising:
introducing the aqueous solution into the recess of the receiving element; and
detecting a parameter of a reaction carried out using the introduced aqueous solution in the receiving element.

13. A control unit comprising:
at least one memory; and
at least one computing unit configured to execute program instructions stored in the at least one memory to perform the method according to claim 12.

14. A computer program comprising:
program code stored on a non-transitory machine-readable carrier or storage medium and configured to execute the method according to claim 12.

15. A machine-readable storage medium on which the computer program according to claim 14 is stored.

16. The microfluidic receiving element as claimed in claim 1, wherein the at least one protrusion has a hydrophilic surface quality.

17. The microfluidic receiving element as according to claim 2, wherein a radius of the tip of the serration is smaller than 25 μm.

18. The microfluidic receiving element according to claim 2, wherein a radius of the tip of the serration is smaller than 15 μm.

19. The microfluidic receiving element according to claim 5, wherein the side wall forms an angle of between 85 and 95 degrees to the upper side.

20. The microfluidic receiving element according to claim 5, wherein the surface-to-volume ratio of the recess is 1.0-1.5 times the surface-to-volume ratio of a cylindrical recess of the same volume having the circular cross-sectional area.
